(19) United States
(12) Patent Application Publication
(10) Pub. No.: US 2005/0160647 A1
(43) Pub. Date: Jul. 28, 2005

(54) Knock-down sign

(76) Inventor: Harold E. Brown, Greensboro, NC (US)

Correspondence Address: Charles Y. Lackey, PO BOX 5871, Greensboro, NC, 27113-5871, US

(21) Appl. No.: 10/764,305

(22) Filed: Jan. 26, 2004

(51) Int. Cl. G09F 15/02

(52) U.S. Cl. 40/607.1

(57) ABSTRACT

A modular sign for use in a business conference environment where there is a need identify specific people or groups having a base, a vertical support member and additional vertical and horizontal member all of which are arranged to carry and display a display member. The display member has a signage face on each side. The sign is easily broken into individual horizontal and vertical member for storage and travel.

### BACKGROUND OF THE INVENTION

1. Field of the Invention

The present invention relates to signs and, more particularly, to a modular or knock-down sign for indoor or outdoor use.

2. Description of the Prior Art

Prior art signs designed for portability typically have included a frame and a board, sheet, or other planar element for showing the letters and pictures to be displayed. The planar element is stretched over, slid into, or otherwise fastened to the frame. There must also be a means for locating or positioning the frame. If the frame will not sit stably upon a surface under its weight, it is usually positioned by hanging it or otherwise bracing it in a display position.

Identification signs are used extensively at business conferences, sales of real estate, identifiers for groups or parties at social engagements and at social clubs for directing potential new members to move generally in a predetermined direction and stop and meet new members in a logical sequence.

In the prior art, the structures of signs used, for example, by realtors are widely varied, some being much more convenient and practical than others. There are often complaints from people who use these signs frequently about the difficulty and inconvenience associated with carrying them in an automobile, their general awkwardness and the difficulties involved in placing them in a display position. To deal with these problems, installers sometimes must carry several tools such as a hammer, screwdriver and wrenches in their automobiles.

Thus there is a real need in the art for a more convenient, durable and versatile sign structure which is easy to transport in an automobile in a knocked-down state, and which can be easily assembled at a property site with an absolute minimum of physical effort and tools. It is to this need that the present invention is directed.

### SUMMARY OF THE INVENTION

The present invention is a modular sign for use in business conferences, social gatherings, conventions and other situations where there is a need to identify individuals, groups, consultants or other people who need to be locatable in a gathering of large numbers of people. The sign consists in part of a base, a vertical support member connected with the base, a lower horizontal member supported by the vertical support member and upreaching members connected with the lower horizontal member. An upper horizontal member joins the upreaching members, and a display member is positioned between the upreaching members and below the upper horizontal member. The display has a signage face on both sides and is movably connected to the upper horizontal member for support.

From the summary it can be seen that one object of the present invention is to provide an improved modular sign that is attractive, inexpensive, sturdy and portable.

Another object of the present invention is to provide a sign that can be assembled and disassembled without tools or with a minimum number of tools.

A further object of the present invention is to provide a sign whose parts can be easily transported and stored.

Thus there has been outlined the more important features of the invention in order that the detailed description that follows may be better understood and in order that the present contribution to the art may be better appreciated. There are, of course, additional features of the invention that will be described hereinafter and which will form the subject matter of the claims appended hereto. In that respect, before explaining at least one embodiment of the invention in detail, it is to be understood that the invention is not limited in its arrangement of the components set forth in the following description and illustrated in the drawings. The invention is capable of other embodiments and of being practiced and carried out in various ways.

It is also to be understood that the phraseology and terminology employed herein are for the purpose of description and should not be regarded as limiting in any respect. Those skilled in the art will appreciate that the concept upon which this disclosure is based may readily be utilized as a basis for designing other structures, methods and systems for carrying out the several purposes of this development. It is important that the claims be regarded as including such equivalent methods and products resulting therefrom that do not depart from the spirit and scope of the present invention. The application is neither intended to define the invention of the application, which is measured by its claims, nor to limit its scope in any way.

Thus, the objectives of the invention set forth above, along with the various features of novelty which characterize the invention, are noted with particularity in the claims annexed to and forming a part of this disclosure. For a better understanding of the invention, its operating advantages and the specific results obtained by its use, reference should be made to the following detailed specification taken in conjunction with the accompanying drawings wherein like characters of reference designate like parts throughout the several views.

The drawings are included to provide a further understanding of the invention and are incorporated in and constitute a part of this specification. They illustrate embodiments of the invention and, together with their description, serve to explain the principles of the invention.

### BRIEF DESCRIPTION OF THE DRAWING

FIG. 1 is a perspective view of the sign constituting the present invention;

FIG. 2 is a front elevational and perspective view of the sign shown in FIG. 1;

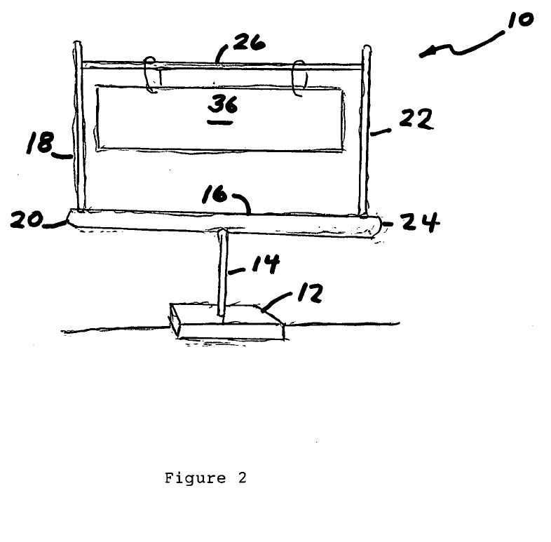

FIG. 3 is a perspective view of the sign shown in FIGS. 1 and 2 in a partially disassembled condition; and

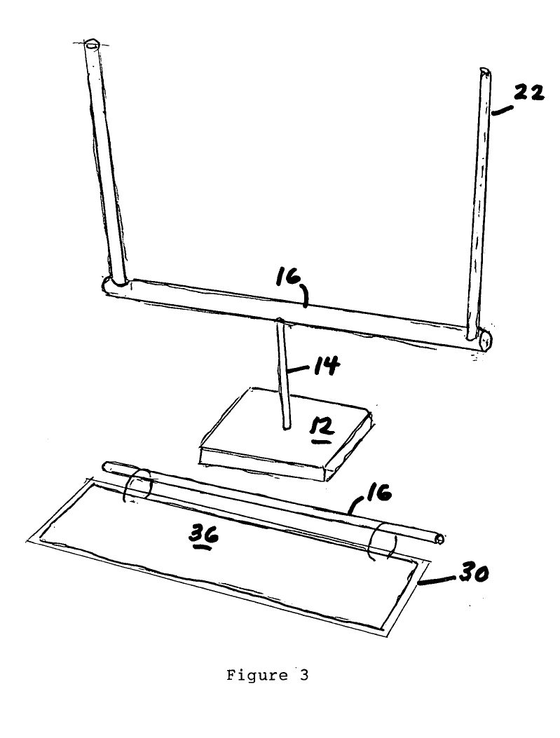

FIG. 4 is a perspective view of the sign shown in FIGS. 1, 2 and 3 in the totally disassembled condition.

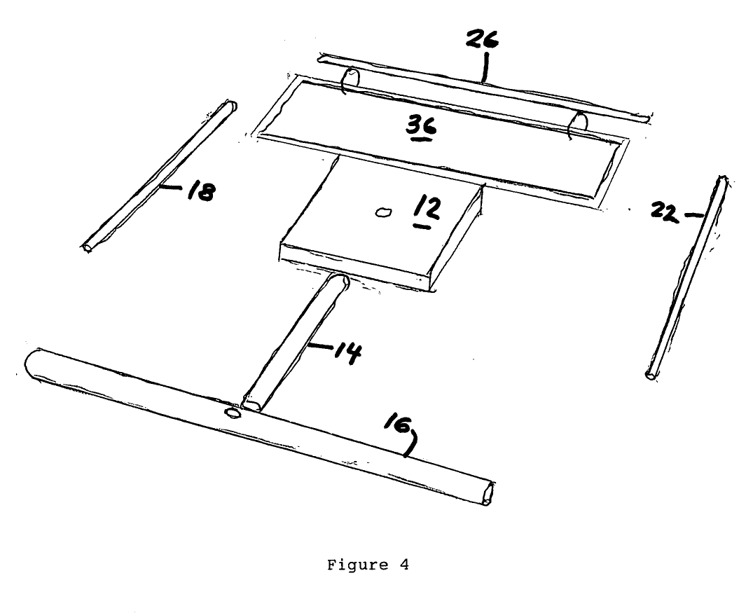

### DETAILED DESCRIPTION OF THE PREFERRED EMBODIMENT

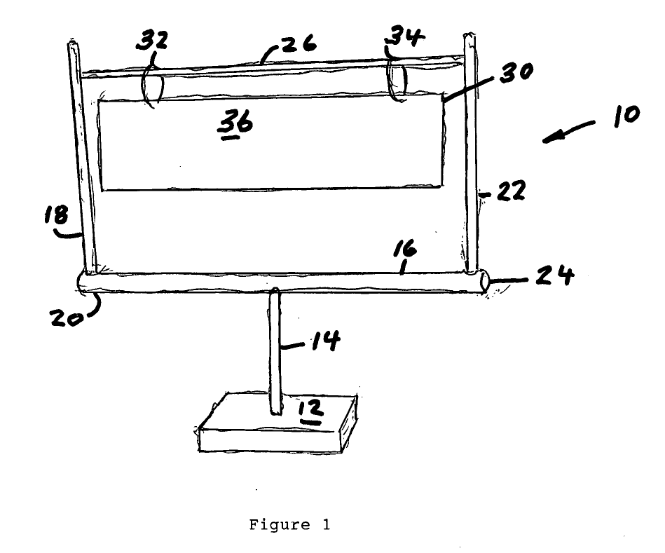

Referring now to the drawings and particularly to FIG. 1, the knock-down sign of the present invention shown generally as 10 is made up of a base 12, a vertical support member 14 extending upwardly from base 10 and connected with and supporting lower horizontal member 16. A first upreaching member 18 extends upwardly from the first end 20 of horizontal member 16, and a second upreaching member 22 extends in a similar manner from second horizontal end 24. First and second upreaching members 18, 22 are connected near their upper ends by upper horizontal member 26.

A display member 30 is positioned between upreaching members 18, 22 and is connected to upper horizontal member 26 by movable rings 32, 34. Display member 30 swings somewhat freely from upper horizontal member 26 because of the use of these rings 32, 34. Obviously any number of other connectors can be used to connect display member 30 to upper horizontal member 26.

Display member 30 has a first sign face 36 and a second sign face (not shown) on the other side of display member 30, both of which can be used to show written material, posters or pictures. The material on each sign face can be the same or can be different depending upon the wishes of the advertiser or sign owner.

The materials used in sign lo in the version illustrated and described herein have a cylindrical cross section except for display frame which is rectangular both in a full side view and in cross section. Other materials having oval, square and rectangular cross sections may be used with equal success. The materials used for the members may be wood, plastic, acrylic or anything that can be formed into a desired shape and retain that shape under normal use conditions.

From the preceding description, it can be seen that a knock-down sign has been provided that will meet all of the advantages of prior art devices and offer additional advantages not heretofore achievable. With respect to the foregoing invention, the optimum dimensional relationship to the parts of the invention including variations in size, materials, shape, form, function, and manner of operation, use and assembly are deemed readily apparent to those skilled in the all equivalent relationships illustrated in the drawings and described in the specification are intended to be encompassed herein.

The foregoing is considered as illustrative only of the principles of the invention. Numerous modifications and changes will readily occur to those skilled in the art, and it is not desired to limit the invention to the exact construction and operation shown and described. All suitable modifications and equivalents that fall within the scope of the appended claims are deemed within the present inventive concept.

1. A modular sign comprising: a base, a vertical support member releasably secured to the base; a lower horizontal member having first and second ends; first and second upreaching members connected to the first and second lower horizontal member ends; an upper horizontal member having first and second ends, the upper horizontal member first end connecting with the first upreaching member and the upper horizontal member second end connecting with the second upreaching member; a display member positioned between the first and second upreaching members and below the upper horizontal member; and movable connectors joining the display member to the upper horizontal member.

2. A modular sign comprising: a base, a support member secured to the base, a first horizontal member secured to the support member; at least one upreaching member connected to the first horizontal member; an upper horizontal member secured to the at least one upreaching member and below the upper horizontal member; and at least one connector joining the display member to the upper horizontal member.

3. A modular sign as claimed in claim 1 wherein the movable connectors are ring connectors.

4. A modular sign as claimed in claim 2 wherein the at least one connector is a ring connector.

5. A modular sign as claimed in claim 1 wherein the display member has first and second sign faces.

6. A modular sign as claimed in claim 2 wherein the display member has first and second sign faces.

7. A modular sign as claimed in claim 3 wherein the display member has first and second sign faces.

8. A modular sign as claimed in claim 4 wherein the display member has first and second sign faces.
